(19) United States
(12) Patent Application Publication
(10) Pub. No.: US 2020/0381978 A1
(43) Pub. Date: Dec. 3, 2020

(54) MOTOR AND ELECTRICAL DEVICE INCLUDING SAME

(71) Applicant: Nidec Corporation, Kyoto (JP)

(72) Inventors: Tatsuya ONISHI, Dalian (CN); Yusaku YOSHIDA, Dalian (CN)

(21) Appl. No.: 16/826,377

(22) Filed: Mar. 23, 2020

(30) Foreign Application Priority Data
May 31, 2019 (CN) 201910468602.2

(51) Int. Cl. H02K 5/26

(52) U.S. Cl. CPC H02K 5/26

(57) ABSTRACT

A motor includes a housing and a first press-in member pressed into the housing. An inner surface of the housing is provided with a first opposing surface and a second opposing surface opposite to the first press-in member in a radial direction. The first opposing surface is located on a side of the second opposing surface in an axial direction. The first opposing surface abuts against a portion of a surface of the first press-in member in the radial direction, and at least a portion of a surface, abutting against the first press-in member, of the first opposing surface is a smooth surface. The second opposing surface does not abut against the first press-in member in the radial direction, and includes a roughened surface.

### CROSS REFERENCE TO RELATED APPLICATION

The present application claims priority under 35 U.S.C. § 119 to Chinese Application No. 201910468602.2 filed on May 31, 2019, the entire contents of which are hereby incorporated herein by reference.

### 1. Field

The disclosure relates to a motor and an electrical device.

### 2. Background

During assembly of an inner rotor motor, a stator iron core needs to be pressed into the housing of the motor. Since the housing is normally subjected to a casting molding process, the inner surface thereof is a rough surface which is uneven and has a relatively large amount of friction. Therefore, it is difficult to press the stator iron core into the housing.

In the related art, before the stator iron core is pressed into the housing, the inner surface of the housing is normally subjected to a cutting process to provide a smoother surface, so as to make it possible to easily press the stator iron core into the housing.

It should be noted that the introduction in Background is merely provided for the convenience of clearly and comprehensively describing the technical solutions of the disclosure and facilitating the understanding of those skilled in the art. These technical solutions discussed above shall not be deemed well-known by those skilled in the art simply for having been described in Background.

### SUMMARY

The inventors of the instant application discovered that processing the entire inner surface of a housing to be a smooth surface takes time and effort, such that the assembling efficiency is lower.

According to a first example embodiment of the present invention, a motor includes a rotating shaft extending along a central axis, a housing arranged about the rotating shaft, and a first press-in member pressed into the housing. An inner surface of the housing is provided with a first opposing surface and a second opposing surface that are opposite to the first press-in member in a radial direction, where the first opposing surface is located on a side of the second opposing surface in an axial direction. The first opposing surface abuts against a portion of a surface of the first press-in member in the radial direction, and at least a portion of a surface, abutting against the first press-in member, of the first opposing surface is a smooth surface. The second opposing surface does not abut against the first press-in member in the radial direction, and the second opposing surface is a rough surface.

According to a second example embodiment of the present invention, an electrical device includes the motor according to the first example embodiment.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a cross-sectional view of a motor along a central axis according to an example embodiment of the present invention.

FIG. 2 is a schematic view of a housing according to an example embodiment of the present invention observed from a perspective.

FIG. 3 is an enlarged partial view of a portion indicated with a dotted circle in FIG. 1.

FIG. 4 is a top view of a first press-in member provided in the housing according to an example embodiment of the present invention.

FIG. 5 is a top view of a second press-in member according to an example embodiment of the present invention.

FIG. 6 is a side view of the second press-in member according to an example embodiment of the present invention.

### DETAILED DESCRIPTION

The foregoing and other features of the disclosure will become apparent from the following specification with reference to the accompanying drawings. Specific example embodiments of the present disclosure are disclosed in the following specification and the accompanying drawings. The following specification and the accompanying drawings describe several example embodiments to which the principles of the disclosure are applicable. However, it should be understood that, the present disclosure is not limited to the example embodiments described herein, but shall include all modifications, variations and equivalents falling within the scope of the appended claims.

In the example embodiments of the present disclosure, terms such as “first”, “second”, “upper”, “lower” are used to distinguish different elements in terms of names, and are not used to indicate a spatial arrangement or a time sequence of these elements, and these elements should not be limited by these terms. The term “and/or” includes any and all combinations of one or more of listed associated terms. Terms such as “comprise”, “include”, and “have” refer to the existence of the described features, elements, devices or components, but do not exclude the existence or addition of one or more other features, elements, devices or components.

In the example embodiments of the present disclosure, singular forms such as “a/an” and “the” include plural forms and should be understood in a broad sense as a meaning of “a type” or “a kind” instead of “one”. In addition, the term “the” should be understood as including both a singular form and a plural form, unless otherwise clearly stated in the context. In addition, the term “according to” should be understood as “at least partially according to . . . ”, and the term “based on” should be understood as “at least partially based on . . . ”, unless otherwise clearly stated in the context.

In addition, in the following descriptions of the example embodiments of the present disclosure, a radial direction with a central axis of a rotating shaft of a motor as a center is referred to as a “radial direction”, a direction surrounding the central axis is referred to as a “circumferential direction”, a direction along the central axis or a direction parallel or substantially parallel to the central axis is referred to as an “axial direction” or an “extending direction of an axial direction”, a side away from the central axis in the radial direction is referred to as a “radial outer side”, and a side close to the central axis in the radial direction is referred to as a “radial inner side”. However, these definitions are only for convenience of description and are not intended to limit the directions of the motor during manufacturing and in use.

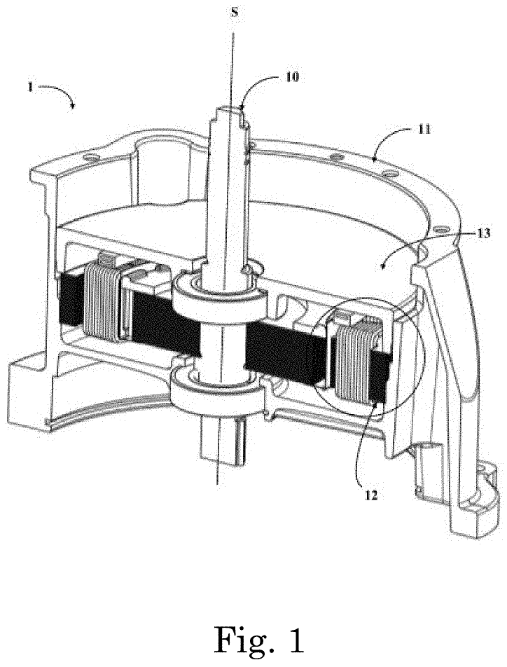

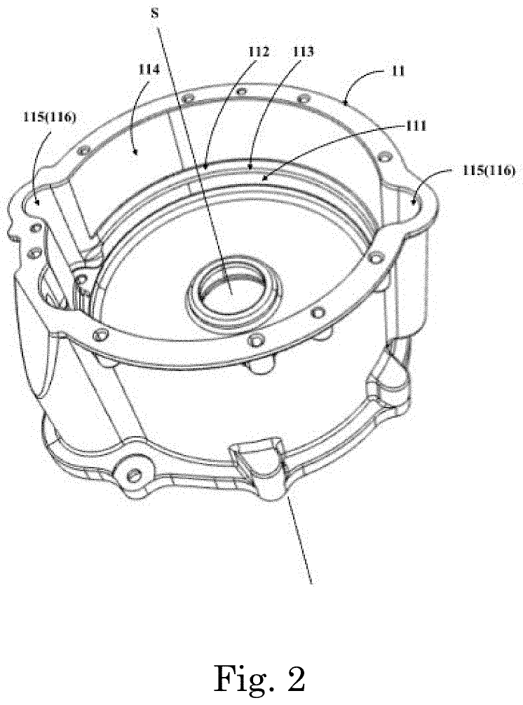

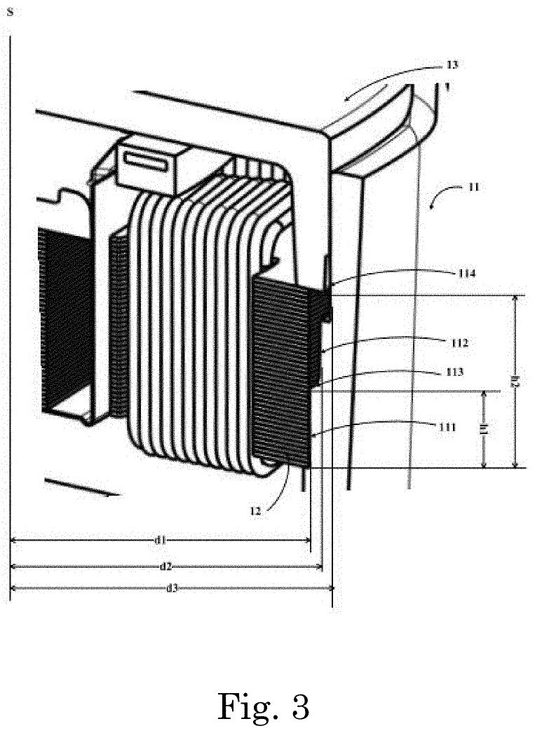

Example Embodiment 1 of the disclosure provides a motor. FIG. 1 is a cross-sectional view of the motor in Exemplary Example Embodiment 1 of the disclosure along a central axis. FIG. 2 is a schematic view of a housing observed from a perspective. FIG. 3 is an enlarged partial view of a portion indicated with a dotted circle in FIG. 1.

In one or more example embodiments of the present disclosure, as shown in FIG. 1, a motor 1 preferably includes a rotating shaft 10 extending along a central axis S, a housing 11 arranged about the rotating shaft 10, and a first press-in member 12. During assembly of the motor 1, the first press-in member 12 is pressed into the housing 11.

As shown in FIG. 2, an inner surface of the housing 11 is provided with a first opposing surface 111 and a second opposing surface 112. The first opposing surface 111 is located on a side of the second opposing surface 112 in an axial direction. As shown in FIG. 3, the first opposing surface 111 is opposite to the first press-in member 12 in a radial direction. The first opposing surface 111 abuts against a portion of a surface of the first press-in member 12 in the radial direction. At least a portion of a surface, abutting against the first press-in member 12, of the first opposing surface 111 is a smooth surface. The second opposing surface 112 does not abut against the first press-in member 12 in the radial direction, and the second opposing surface 112 is preferably a rough surface.

In this way, it is possible to process only at least a portion of the surface, abutting against the press-in member 12, of the first opposing surface 111 to be a smooth surface, and there is no need to process the second opposing surface 112 that does not abut against the first press-in member 12. Accordingly, a processing range in which the inner surface of the housing 11 is made to have a smooth surface is reduced, while ensuring that the press-in member 12 is able to be easily pressed into the housing 11, thus shortening the time required to process the inner surface of the housing 11 and facilitating the working efficiency.

In one or more example embodiments of the present disclosure, it may be that an entirety of the first opposing surface 111 is processed to be a smooth surface, or it may also be that only a portion of the surface abutting against the first press-in member 12 is processed to be a smooth surface. The present example embodiment of the disclosure does not impose a limitation in this regard, provided that the smooth portion of the first opposing surface 111 allows the first press-in member 12 to be successfully pressed into the housing 11. In this way, the processing range in which the inner surface of the housing 11 is a smooth surface is reduced, thus further shortening the time required to process the inner surface of the housing 11, and facilitating the working efficiency.

In one or some example embodiments, as shown in FIG. 3, a total axial height h1 of the first opposing surface 111 is preferably less than a half of a total axial height h2 of the first press-in member 12. Therefore, in a case that the first press-in member 12 is ensured to be reliably secured on the inner surface of the housing, the processing range in which the inner surface of the housing is a smooth surface is further reduced.

In an example embodiment of the present disclosure, the first opposing surface 111 is preferably located, relative to the second opposing surface 112, on a side of the housing 11 in the axial direction that is the same or substantially the same as a press-in direction of the first press-in member 12. In other words, a portion of the first press-in member 12 on a side in the axial direction located at the press-in direction abuts against the first opposing surface 111 located on a side at the press-in direction of the housing 11 after passing through the second opposing surface 112 during a press-in process. In this way, the first press-in member 12 is easily pressed into the housing 11.

In an example embodiment of the present disclosure, the first opposing surface 111 is located farther toward a radially inner portion of the housing 11 than the second opposing surface 112 is. As shown in FIG. 3, a first radial distance d1 from the first opposing surface 111 to the central axis S of the housing 11 is preferably less than a second radial distance d2 from the second opposing surface 112 to the central axis S of the housing 11. The inner surface of the housing 11 preferably further includes a guiding surface 113. The guiding surface 113 connects the first opposing surface 111 and the second opposing surface 112, and is a rough surface. The guiding surface 113 may preferably be a curved substantially “r”-shaped inclined surface extending from the second opposing surface 112 to the first opposing surface 111 in the press-in direction, or may alternatively be a straight-sloped or substantially straight-sloped surface. The present example embodiment of the present disclosure does not impose a limitation in this regard. In this way, the guiding surface 113 is easily to be molded.

In an example embodiment of the present disclosure, the radial size of the first press-in member 12 from an end to the other end in the axial direction preferably remains the same. For example, the first press-in member 12 is cylindrical or substantially cylindrical, rectangular or substantially rectangular, or the like. The present example embodiment of the disclosure does not impose a limitation in this regard.

In this way, when abutting against the first opposing surface 111, the first press-in member 12 does not abut against the second opposing surface 112. Therefore, only the portion of the first opposing surface 111 that abuts against the first press-in member 12 and is located on a side of the housing 11 in the axial direction needs to be processed, and there is no need to process the second opposing surface 112 located on the other side of the housing 11 in the axial direction. In this way, the processing range in which the inner surface of the housing is a smooth surface is reduced, thus shortening the time for processing the inner surface of the housing 11, and facilitating the working efficiency.

In one or some example embodiments, as shown in FIG. 2, the inner surface of the housing 11 is preferably further provided with a third opposing surface 114. The third opposing surface 114 is located on the other side of the second opposing surface 112 in the axial direction. As shown in FIG. 3, the third opposing surface 114 is located farther at the radially outer side of the housing 11 than the second opposing surface 112 is. A third radial distance d3 from the third opposing surface 114 to the central axis S of the housing 11 is preferably greater than the second radial distance d2 from the second opposing surface 112 to the central axis S of the housing 11.

As shown in FIG. 1, the motor 1 preferably further includes a second press-in member 13. During assembly of the motor 1, the second press-in member 13 is pressed into the housing 11. As shown in FIG. 3, the third opposing surface 114 abuts against the second press-in member 13 in the radial direction, and at least a portion of the surface, abutting against the second press-in member 13, of the third opposing surface 114 is a smooth surface. In this way, it is ensured that the second press-in member 13 is easily pressed into the housing 11.

In one or some example embodiments, as shown in FIG. 3, at least a portion of the third opposing surface 114 is opposite to the first press-in member 12 in the radial direction. In this way, a size error of the first press-in member 12 or the second press-in member 13 in the radial direction and a size error in the radial direction during a press-in process is absorbed by the third opposing surface 114, thus lowering the precision requirement on the size of the first press-in member 12 during processing and molding, and further facilitating the working efficiency.

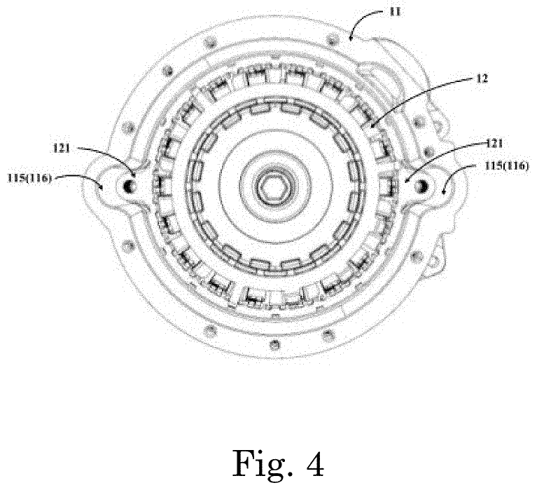

FIG. 4 is a top view of the first press-in member in the housing. In one or some example embodiments, as shown in FIG. 4, the first press-in member 12 is provided with a first protrusion portion 121 protruding toward the radially outer side of the housing 11, the inner surface of the housing 11 is further provided with a first recessed portion 115 recessed toward the radial outer side of the housing 11, and the first protrusion portion 121 is able to be inserted into the first recessed portion 115.

In, this way, the first press-in member 12 is positioned in the circumferential direction of the housing 11 by the first protrusion portion 121 and the first recessed portion 115. It may be that an outer circumferential surface of the first protrusion portion 121 does not abut against the first recessed portion 115, and that an inner surface of the first recessed portion 115 is a rough surface. In this way, the processing range in which the inner surface of the housing is a smooth surface is further reduced. In addition, the quantity of the first protrusion portion 121 is not limited in the present example embodiment. There may be one, two, or more first protrusion portions, provided that the first press-in member 12 is positioned accordingly.

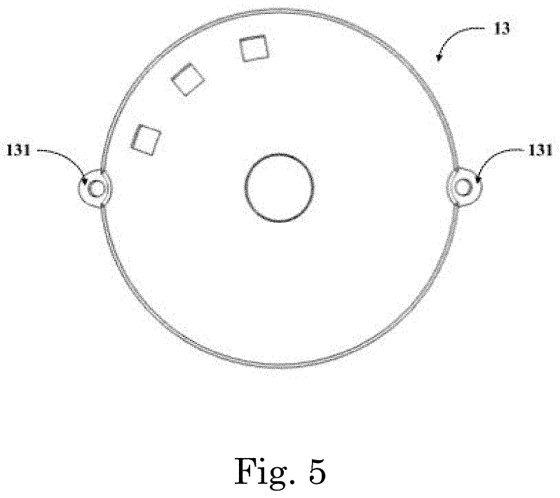

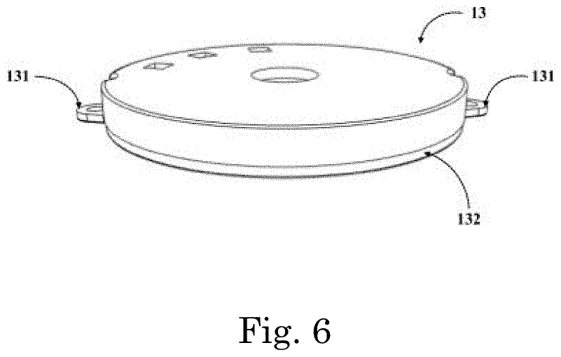

FIG. 5 is a top view of the second press-in member, and FIG. 6 is a side view of the second press-in member. In one or some example embodiments of the present disclosure, as shown in FIG. 5 and FIG. 6, the second press-in member 13 is provided with a second protrusion portion 131 protruding toward the radially outer side. As shown in FIG. 2, the inner surface of the housing 11 is further provided with a second recessed portion 116 recessed toward the radially outer side of the housing 11, and the second protrusion portion 131 is able to be inserted into the second recessed portion 116. In this way, the second press-in member 13 is positioned in the circumferential direction in the housing 11 by the second protrusion portion 131 and the second recessed portion 116. It may be that an inner surface of the second recessed portion 116 does not abut against an outer circumferential surface of the second protrusion portion 131, and that an inner surface of the second recessed portion 116 is a rough surface. In this way, the processing range in which the inner surface of the housing is a smooth surface is further reduced.

In an example embodiment of the present disclosure, as shown in FIG. 6, the second protrusion portion 131 is preferably located on a side of the second press-in member 13 in the axial direction, an outer circumferential surface 132 of the second press-in member 13 on a side in the axial direction and within an axial height range of the second protrusion portion 131 is a rough surface, an outer circumferential surface of the second press-in member 13 on the other side in the axial direction is a smooth surface, and the rough surface 132 of the second press-in member does not abut against the inner circumferential surface of the housing 11. In this way, the processing difficulty of the second press-in member 13 is alleviated, and the processing range in which the inner surface of the housing 11 is a smooth surface is further reduced.

In addition, the quantity of the second protrusion portion 131 is not limited in the present example embodiment of the present disclosure. There may be one, two, or more second protrusion portions, provided that the second press-in member 13 is positioned accordingly.

In another example embodiment of the present disclosure, the second protrusion portion 131 may further include other portions of the second press-in member 13 that protrude toward the radially outer side of the housing 11, such as a handle, a ring, etc. The present example embodiment of the disclosure does not impose a limitation in this regard.

In one or more example embodiments of the present disclosure, the first press-in member 12 may preferably be, for example, a stator iron core of the motor, but the present example embodiment is not limited thereto. The first press-in member 12 may also be another component able to be pressed in the housing 11. In addition, the second press-in member 13 may be, for example, a bearing holder of the motor, but the present example embodiment is not limited thereto. The second press-in member 13 may also be another component able to be pressed into the housing 11, such as a cover. It is only required or preferred that the first press-in member 12 or the second press-in member 13 abuts against the inner surface of the housing 11, and at least a portion of the inner surface of the housing 11 that abuts against the component is processed to be a smooth surface, so that the component is easily pressed into the housing 11, and the processing range in which the inner surface of the housing is a smooth surface is reduced.

In one or more example embodiments of the present disclosure, the first recessed portion 115 and the second recessed portion 116 that are shown in FIG. 2 are located on the same position in the circumferential direction of the housing 11, but the present example embodiment of the present disclosure is not limited thereto. The first recessed portion 115 and the second recessed portion 116 may also be located at different positions in the circumferential direction of the housing 11. In addition, the quantity of the first recessed portion 115 or second recessed portion 116 is also not limited in the present example embodiment of the present disclosure, provided that the first recessed portion 115 and the second recessed portion 116 respectively fit the first protrusion portion 121 and the second protrusion portion 131 to position the first press-in member 12 and the second press-in member 13.

According to the present example embodiment of the disclosure, at least a portion of the inner surface, abutting against the press-in member, of the housing is processed to be a smooth surface, thus shortening a time required to process the inner surface of the housing and facilitating the working efficiency while ensuring that the press-in member is easily pressed into the housing.

An electrical device according to an example embodiment of the present disclosure includes a motor as described above. In the present example embodiment of the present disclosure, the structure of the electrical device is not limited. The electrical device may be a household appliance such as a brake system, an air conditioner, a water dispenser, a washing machine, a sweeper, a compressor, an air supply fan, or a mixer, or may be an electrical device of another field.

According to the present example embodiment of the present disclosure, at least a portion of the inner surface, abutting against the press-in member, of the housing is processed to be a smooth surface, so that the time required to process the inner surface of the housing is shortened and the working efficiency is facilitated, while ensuring that the press-in member is easily pressed into the housing, thus improving the efficiency for assembling the electrical device.

The foregoing describes the disclosure with reference to specific example embodiments. However, a person skilled in the art should understand that these descriptions are exemplary, and are not intended to limit the protection scope of the present disclosure. A person skilled in the art may make various variations and modifications to the disclosure based on the spirit and principles of the disclosure, and those variations and modifications also fall within the scope of the disclosure.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor, comprising:
a rotating shaft extending along a central axis;
a housing arranged about the rotating shaft; and
a first press-in member pressed into the housing; wherein
an inner surface of the housing includes a first opposing surface and a second opposing surface that are both opposite to the first press-in member in a radial direction;
the first opposing surface is located on a side of the second opposing surface in an axial direction;
the first opposing surface abuts against a portion of a surface of the first press-in member in the radial direction, and at least a portion of the first opposing surface, abutting against the first press-in member, is a smooth surface; and
the second opposing surface does not abut against the first press-in member in the radial direction, and the second opposing surface is a rough surface.

2. The motor according to claim 1, wherein the first opposing surface is located, relative to the second opposing surface, on a side of the housing in the axial direction that is the same or substantially the same as a press-in direction of the first press-in member.

3. The motor according to claim 2, wherein
a radial size of the first press-in member from an end to another end in the axial direction is constant or substantially constant; and
the first opposing surface is located farther at a radially inner side of the housing than the second opposing surface is.

4. The motor according to claim 2, wherein
the inner surface of the housing includes a guiding surface connecting the first opposing surface and the second opposing surface; and
the guiding surface is a rough surface.

5. The motor according to claim 1, further comprising a second press-in member pressed into the housing; wherein
the inner surface of the housing includes a third opposing surface located on another side of the second opposing surface in the axial direction;
the third opposing surface abuts against the second press-in member in the radial direction, and at least a portion of a surface, abutting against the second press-in member, of the third opposing surface is a smooth surface; and
the third opposing surface is closer to a radially outer side of the housing than the second opposing surface is.

6. The motor according to claim 1, wherein a total axial height of the first opposing surface is less than a half of a total axial height of the first press-in member.

7. The motor according to claim 5, wherein at least a portion of the third opposing surface is opposite to the first press-in member in the radial direction.

8. The motor according to claim 1, wherein
the first press-in member includes a first protrusion portion protruding toward a radially outer side of the housing; and
the inner surface of the housing includes a first recessed portion recessed toward the radially outer side of the housing;
the first protrusion portion is able to be inserted into the first recessed portion;
an inner surface of the first recessed portion does not abut against an outer circumferential surface of the first protrusion portion; and
the inner surface of the first recessed portion is a rough surface.

9. The motor according to claim 5, wherein
the second press-in member includes a second protrusion portion protruding toward the radially outer side of the housing;
the inner surface of the housing includes a second recessed portion recessed toward the radial outer side of the housing;
the second protrusion portion is able to be inserted into the second recessed portion;
an inner surface of the second recessed portion does not abut against an outer circumferential surface of the second protrusion portion; and
the inner surface of the second recessed portion is a rough surface.

10. The motor according to claim 9, wherein
the second protrusion portion is located on a side of the second press-in member in the axial direction;
an outer circumferential surface of the second press-in member on a side in the axial direction and within an axial height range of the second protrusion portion is a rough surface;
an outer circumferential surface of the second press-in member on another side in the axial direction is a smooth surface; and
the rough surface of the second press-in member does not abut against the inner circumferential surface of the housing.

11. An electrical device, comprising the motor according to claim 1.
